(19) United States
(12) Patent Application Publication
(10) Pub. No.: US 2015/0317652 A1
(43) Pub. Date: Nov. 5, 2015

(54) Sales Management System

(71) Applicant: Nits Solutions, Inc., Farmington Hills, MI (US)

(72) Inventors: Sanjay Seth, Novi, MI (US); Neetu Seth, Novi, MI (US)

(73) Assignee: Nits Solutions, Inc., Farmington Hills, MI (US)

(21) Appl. No.: 14/676,218

(22) Filed: Apr. 1, 2015

Related U.S. Application Data
(60) Provisional application No. 61/987,116, filed on May 1, 2014.

(51) Int. Cl. G06Q 30/02; G06F 17/30; G06Q 30/00

(52) U.S. Cl. CPC G06Q 30/0204; G06Q 30/016; G06F 17/30345; G06F 17/30589

(57) ABSTRACT

A method includes receiving a set of customer records and identifying any duplicate customers within the set of customer records. The method includes consolidating customer records of any duplicate customers, and identifying whether any customers represented within the received set of customer records have an existing customer record in data store hardware. The method includes receiving a segmentation criteria defined as an active customer, an inactive customer, or a prospective customer, and segmenting the customers in the data store hardware based on the segmentation criteria. The method includes assigning an active status to active customers. The active status being active defecting (customer having no associated purchase history) or active declining (customer having a threshold decrease in sales over a third period of time). The method also includes associating customer metrics with the customers, and generating a report illustrating the customer segmentation and customer metrics.

### CROSS REFERENCE TO RELATED APPLICATIONS

This U.S. patent application claims priority under 35 U.S.C. §119(e) to U.S. Provisional Application 61/987,116, filed on May 1, 2014, which is hereby incorporated by reference in its entirety.

### TECHNICAL FIELD

This disclosure relates to a sales management system for managing the wholesale of goods and merchandise to intermediate customers and individual purchases.

### BACKGROUND

Wholesaling or distributing goods or merchandise is the process of selling the goods or merchandise to retailers; industrial, commercial, institutional, or other professional business users; or to other wholesalers and related sub coordinated services. in other words, wholesaling or distributing is the sale of goods or merchandise to anyone other than the end-user or the consumer. In some examples, wholesalers or distributors sell the goods or merchandise to one layer of intermediary customers before reaching the end customer. In other examples, the wholesalers or distributors sell the goods or merchandise to multiple layers of intermediary customers before the goods or merchandise reach the end customer. Sometimes, the wholesalers have to keep track of all the goods being sold to the different intermediary customers. Maintaining a record of such information may be cumbersome and difficult due to the large amount of information.

### SUMMARY

One aspect of the disclosure provides a method that includes receiving, at a data processing device, a set of customer records corresponding to customers and identifying, using the data processing device, any duplicate customers represented within the set of customer records. The method also includes consolidating, using the data processing device, customer records of any duplicate customers as each having a consolidated customer record and identifying, using the data processing device, whether any customers represented within the received set of customer records have an existing customer record in a data store (e.g., data store hardware). When a customer has an existing customer record in the data store, the method includes updating, using the data processing device, the existing customer record in the data store based on the corresponding received customer record or the corresponding consolidated customer record. Moreover, when the data store lacks a customer record corresponding to a customer, the method includes inserting, using the data processing device, a new customer record in the data store based on the corresponding received customer record or the corresponding consolidated customer record. The method also includes receiving, at the data processing device, a segmentation criteria defined as an active customer, an inactive customer, or a prospective customer. An active customer has an active associated purchase history within a first threshold period of time, an inactive customer has an inactive associated purchase history of the first threshold period of time, and a prospective customer has no associated purchase history. The method includes segmenting the customers in the data store, using the data processing device, based on the segmentation criteria. The method also includes assigning an active status to active customers, the active status being active defecting or active declining. An active defecting customer has no associated purchase history within a second threshold period of time shorter than the first threshold period of time, and an active declining customer has a threshold decrease in sales over a third period of time. The method finally includes associating customer metrics with the customers, and generating, using the data processing device, a report illustrating the customer segmentation and customer metrics.

In some implementations, the method further includes displaying on an electronic display one or more segmentation criteria input fields and receiving the segmentation criteria from one or more segmentation criteria input fields. The segmentation criteria include a customer type and a customer status within the customer type. The customer type may be defined as a dealer, body shop, a repair shop, a shop specialty, a distance from a dealer, and/or a brand.

Another aspect of the disclosure provides a method including receiving, at a data processing device, a set of customer records corresponding to customers and identifying, using the data processing device, any duplicate customers represented within the set of customer records. The method also includes consolidating, using the data processing device, customer records of any duplicate customers as each having a consolidated customer record and identifying, using the data processing device, whether any customers represented within the received set of customer records have an existing customer record in a data store (e.g., data store hardware). The method also includes when a customer has an existing customer record in the data store, updating, using the data processing device, the existing customer record in the data store based on the corresponding received customer record or the corresponding consolidated customer record. The method also includes when the data store lacks a customer record corresponding to a customer, inserting, using the data processing device, a new customer record in the data store based on the corresponding received customer record or the corresponding consolidated customer record. The method also includes receiving, at the data processing device, segmentation criteria including a customer type defined as a dealer, body shop, a repair shop, a shop specialty, a distance from a dealer, and/or a brand. The method also includes segmenting the customers in the data store, using the data processing device, based on the segmentation criteria and associating customer metrics with the customers. The method also includes generating, using the data processing device, a report illustrating the customer segmentation and customer metrics.

In some implementations, the segmentation criteria include a customer type defined as an active customer, an inactive customer, or a prospective customer. An active customer has an active associated purchase history within a first threshold period of time, an inactive customer has an inactive associated purchase history of the first threshold period of time, and a prospective customer has no associated purchase history. The method may further include assigning an active status to active customers, the active status being active defecting or active declining. An active defecting customer has no associated purchase history within a second threshold period of time shorter than the first threshold period of time and an active declining customer has a threshold decrease in sales over a third period of time.

Implementations of the disclosure may include one or more of the following features. The method may further include determining the customer type of each customer based on a name of the customer or based on a word match between a list of words and a name of the customer.

In some examples, the method includes generating and displaying on the electronic display an interactive report that provides cascading information for the customer type and the customer status. The customer metrics may include sales and generating the report includes generating a table or graphical illustration illustrating a sales trend over a period of time.

Yet another aspect of the disclosure provides a system including a data store (e.g., data store hardware), a customer receiver executing on a data processing device and in communication with the data store, a segmenter in communication with the data store, and a reporter in communication with the data store. The system also includes receiving a set of customer records corresponding to customers and identifying any duplicate customers represented within the set of customer records. The system also includes consolidating customer records of any duplicate customers as each having a consolidated customer record and identifying whether any customers represented within the received set of customer records have an existing customer record in a data store. When a customer has an existing customer record in the data store, the system includes updating the existing customer record in the data store based on the corresponding received customer record or the corresponding consolidated customer record and when the data store lacks a customer record corresponding to a customer, the system includes inserting a new customer record in the data store based on the corresponding received customer record or the corresponding consolidated customer record The segmenter receives a segmentation criteria and segments the customers in the data store based on the segmentation criteria The reporter associates customer metrics with the customers and generates a report illustrating the customer segmentation and customer metrics.

In some implementations, the segmentation criteria include a customer type defined as an active customer, an inactive customer, or a prospective customer. An active customer may have an active associated purchase history within a first threshold period of time, an inactive customer may have an inactive associated purchase history of the first threshold period of time, and a prospective customer may have no associated purchase history. The system further includes assigning an active status to active customers, the active status being active defecting or active declining, an active defecting customer having no associated purchase history within a second threshold period of time shorter than the first threshold period of time, and an active declining customer having a threshold decrease in sales over a third period of time.

In some examples, the system further includes an electronic display in communication with the data processing device. The electronic display may display one or more segmentation criteria input fields and receive the segmentation criteria from one or more segmentation criteria input fields. The segmentation criteria may include a customer type and a customer status within the customer type. The system where the segmentation criteria includes a customer type defined as a dealer, body shop, a repair shop, a shop specialty, a distance from a dealer, and/or a brand.

In some implementations, the segmenter determines the customer type of each customer based on a name of the customer or based of each customer a word match between a list of words and a name of the customer. The reporter may generate and display on the electronic display an interactive report that provides cascading information for the customer type and the customer status. The customer metrics may include sales and generating the report may include generating a table or graphical illustration illustrating a sales trend over a period of time.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an exemplary sales management system.

FIG. 2A is a schematic view of an exemplary sales management system.

FIG. 2B is a schematic view of an exemplary customer receiver of the exemplary sales management system, as it receives customer records.

FIGS. 3A-3C are schematic views of an exemplary flow chart of a process of managing received customer records within a sales management system.

FIGS. 4A-4D are schematic views of exemplary views showing a result set.

FIGS. 5A and 5B are schematic views of exemplary arrangements of operations for managing customer records.

FIGS. 6A and 6B are schematic views of exemplary arrangements of operations for managing customer records.

Like reference symbols in the various drawings indicate like elements.

### DETAILED DESCRIPTION

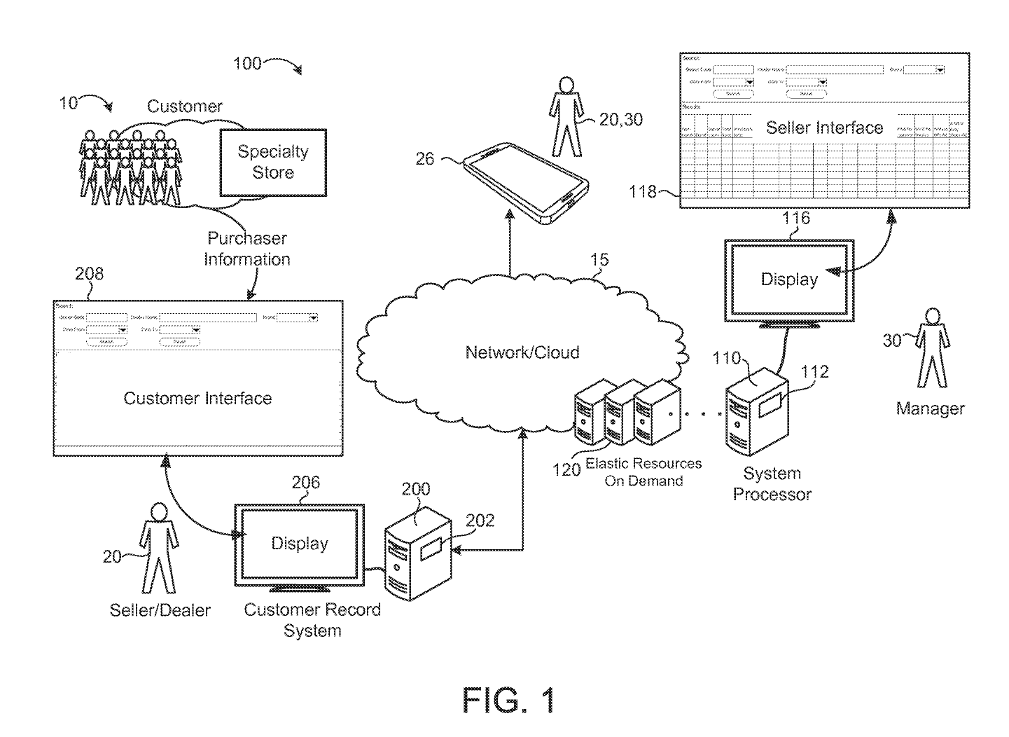

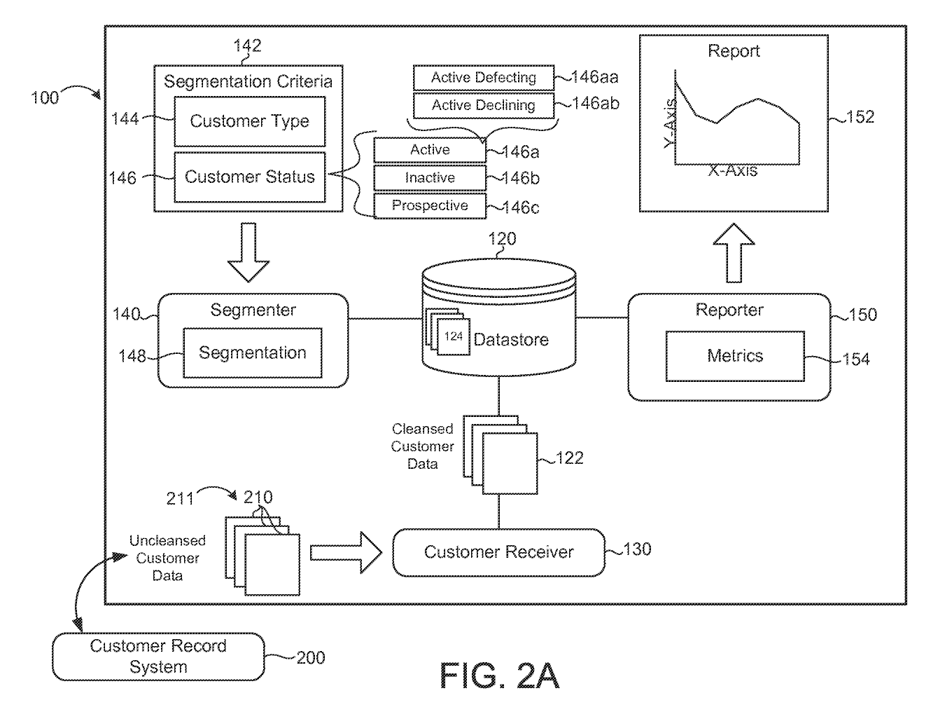

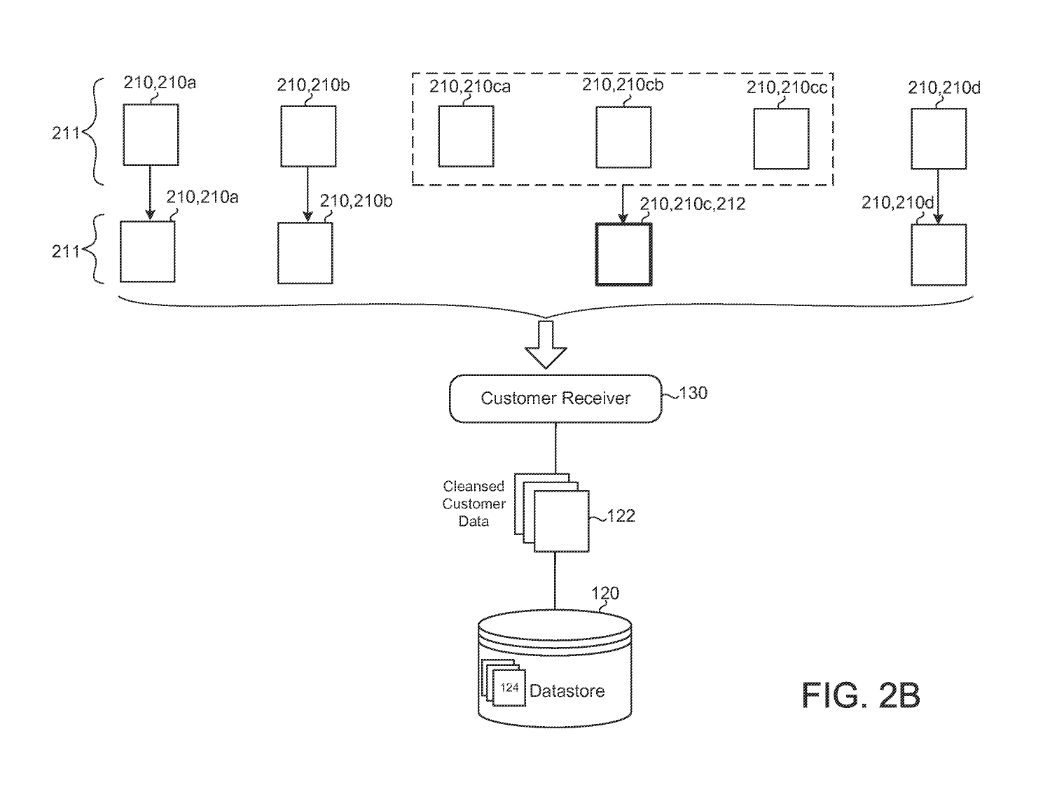

Referring to FIGS. 1-2B, in some implementations, a system 100 organizes purchases made by customers 10 from a seller 20 (e.g., a dealer) so that a manager 30 (e.g., wholesale) can monitor the transactions. The customer 10 may be an individual purchaser or a specialty shop. The system 100 retrieves information from one or more sellers 20 relating to purchases of customers 10 and organizes the retrieved information. The system 100 analyzes the information and reports that information to the manager 30 and/or the one or more sellers 20 based on specific segmentation criteria 142. The system 100 provides several features and functions that include: allowing the seller 20 to enter (via a seller display 206) information retrieved from customers 10; a master data store 120 (e.g., storage hardware) that includes information retrieved from one or more of the sellers 20 pertaining to customers 10; capability of customer segmentation and filtering, reporting and tracking; and turnkey and inventory support. The manager 30 can analyze sales information based on each one of its individual sellers 20 or a combination of multiple sellers 20. Moreover the manager 30 can analyze the sales based on specific products or goods sold. For example, if a wholesale manager 30 sells automotive parts to sellers 20, e.g., car dealerships, who in turn sell the automotive parts to customers 10, the system 100 facilitates the tracking, analyzing, and purchasing of automotive parts from the wholesale manager 30. Therefore, the wholesale manager 30 can track which of its sellers 20 is selling the most parts and to whom and which part among all the sellers 20 is being purchased the most or the least. Although most of the description relates to an automotive wholesale manager 30, an automotive seller 20, such as an automotive dealer selling automotive parts, and a customer 10 buying the automotive parts (as an individual or for resale), the system 100 may be applied to any customers 10 buying from a seller 20, who is in turn buying from a manager 30 or being managed by a wholesaler 30. Therefore, the system 100 may be applied to any goods or services sold having a middle man (i.e., the seller 20).

The system 100 includes a data store 120 (e.g., non-transitory memory) in communication with the one or more sellers 20 via a network 15. The data store 120 store customer records 122 received from multiple sellers 20. The network 15 may include any type of network that allows sending and receiving communication signals, such as a wireless telecommunication network, a cellular telephone network, a time division multiple access (TDMA) network, a code division multiple access (CDMA) network, Global system for mobile communications (GSM), a third generation (3G) network, fourth generation (4G) network, a satellite communications network, and other communication networks. The network 15 may include one or more of a Wide Area Network (WAN), a Local Area Network (LAN), and a Personal Area Network (PAN). In some examples, the network 15 includes a combination of data networks, telecommunication networks, and a combination of data and telecommunication networks. In some examples, the network 15 provides access to cloud computing resources, which may be elastic/on-demand computing and/or storage resources available over the network 15. The term ‘cloud’ services generally refers to a service performed not locally on a user's device, but rather delivered from one or more remote devices accessible via one or more networks 15.

The system 100 includes a one or more data processing devices 110 (e.g., computing device) having a non-transitory memory 112. The system 100 also includes a customer receiver 130, a segmenter 140, and a reporter 150 executing on the one or more data processing devices 110.

The customer receiver 130 executes on the data processing device(s) 110 and communicates with the data store 120. The customer receiver 130 receives customer records 210 corresponding to customers 10. The customer records 210 include customer name, customer telephone number, website, email address, and/or any other information pertaining to the customer 10. The customer records 210 also include sales of goods, purchaser visits, and services rendered or purchases made.

The customer receiver 130 receives the customer records 210 from multiple sellers 20 and sorts through the customer records 210 to identify any duplicate customers 10 within the received customer records 210. Referring to FIG. 2B, in some examples, the received customer records 210 have duplicate records 210. A record set 211 includes multiple records 210a, 210b, 210ca, 210cb, 210cd, 210d. The customer receiver 130 may determine that records 210ca, 210cb, 210cd are multiple entries of the same customer 10. The customer receiver 130 consolidates these records 210ca, 210cb, 210cd into one consolidated record 210c. The customer receiver 130 can then determine if any of the received records 210 and consolidated records 212 have stored customer records previously stored in the data store 120.

In some examples, the customer receiver 130 identifies if any customer 10 represented within the received set of customer records 210 (including consolidated customer records 212) have an existing customer record 122 in the data store 120. If so, the customer receiver 130 updates the existing customer record 122 in the data store 120 based on the corresponding received customer record 210 or the corresponding consolidated customer record 212. However, if the data store 120 does not have a customer record 122 that corresponds to the customer 10, the customer receiver 130 inserts the customer record 210 in the data store 120 based on the corresponding received customer record 210 or the corresponding consolidated customer record 212. For example, if the customer receiver 130 receives a customer record 210 pertaining to John Smith, a customer 10, the customer receiver 130 determines if the data store 120 has a stored customer record 122 for John Smith. If the data store 120 contains the customer record 210 of the customer 10, for John Smith, then the customer receiver 130 determines that there is a duplicate record 210 for John Smith. In this case, the customer receiver 130 updates the existing customer record 122 in the data store 120. However, if the data store 120 does not contain the customer record 210 of the customer 10, then the customer receiver 130 inserts a new customer record 122 for the customer 10 in the data store 120, in this example, for John Smith. In some examples, the customer receiver 130 associates a customer ID with each stored customer record 122.

The segmenter 140 is in communication with the data store 120. The segmenter 140 receives the segmentation criteria 142 and segments the stored customer records 122 in the data store 120 based on the segmentation criteria 142. The segmentation criteria 142 may include a customer status 146 defined as an active customer 146a, an inactive customer 146b, or a prospective customer 146c. An active customer 146a has an active associated purchase history within a first threshold period of time, for example, within the last 90 days. In some examples, the first threshold period of time is increased or decreased based on the seller 20 or manager 30 preferences. An inactive customer 146b has an inactive associated purchase history of the first threshold period of time, i.e., the customer 10 has not made any purchases from the seller 20 within the past 90 days. In some examples, an inactive customer 146b has an inactive associated purchase history for the first threshold period of time, but has an active associated purchase history for the second threshold period of time. For example, an inactive customer 146b may be a customer 10 who has not purchased from the seller 20 in the last 90 days (first threshold period of time), but has made purchases in the last 24 months (second threshold period of time). The prospective customer 146c has no associated purchase history with the seller 20. In some examples, the prospective customer 146c has an interactive associated history for a third threshold period of time. For example, the prospective customer 146c has not made any purchases in the last 24 months (third threshold period of time).

When the segmenter 140 assigns an active customer 146a status to a customer 10, the active status 146a may be further divided into an active defecting status 146aa or an active declining status 146ab. The active defecting status 146aa is associated with a customer 10 who has no associated purchase history within an active threshold period of time that is shorter than the first threshold of time. For example, the active threshold period of time may be 60 days, which is less than 90 days, the first threshold period of time. Thus, a customer 10 who has not made any purchases from the seller 20 over 60 days but less than 90 days has an active defecting status 146aa. An active declining status 146ab of a customer 10 is when the customer 10 has a threshold decrease in sales over a third period of time, i.e., when the customer's sales are decreasing over the third period of time. The third period of time may be set to one year, two years, a number of years, or the duration that the customer 10 has been purchasing from the seller 20. In some examples, the customer 10 has a status of active defecting 146aa, active declining 146ab, or both. If the customer 10 has an active defecting status 146aa and an active declining status 146ab, then the customer 10 has not made any purchases within the third threshold period of time, and the customer's sales are decreasing.

In some examples, the segmentation criteria 142 includes a customer type 144 defined as a dealer, body shop, a repair shop, shop specialty, a distance from a dealer/seller 20, and/or a brand. The segmentation criteria 142 are criteria that determine characteristics of the customer 10, as compared to the customer status 146, which determines the actions of a customer 10. The segmenter 140 may determine the customer type 144 of each customer 10 based on the name of the customer 10 stored in the data store 120, and previously received by the customer receiver 130. For example, if the customer name is “Joe's Body Shop,” the segmenter 140 determines that the customer type 144 is a body shop. In another example, where the customer name is “Sal's Auto-Parts,” the segmenter 140 determines that the customer type 144 is an auto part seller. The segmenter 140 may determine the customer type 144 based on specific word matches between a list of words and a name of the customer 10. The list of words may be determined by the manager 30 and the segmenter 140 may associate specific words with the customer type 144. For example, the list of words may include: parts, auto-parts, engines, transmission; if the customer name includes any of these words, the segmenter 140 determines that the customer type 144 is a body shop.

The reporter 150 is in communication with the data store 120. The reporter 150 associates customer metrics 154 with the customers 10 and generates a report 152 illustrating the customer segmentation 148 and customer metrics 154. The customer metrics 154 may include sales information and/or inventory information. The reports 152 may include a table or graphical illustration illustrating customer metrics 154, such as a sale trend over a period of time. The reporter 150 generates an interactive report 152 for display on an electronic display 206, 116 that provides cascading information for the customer type 144 and the customer status 146. In some implementations, the seller 20 or the manager 30 views the report 152 on a web browser or a web-based application in communication with the network 15.

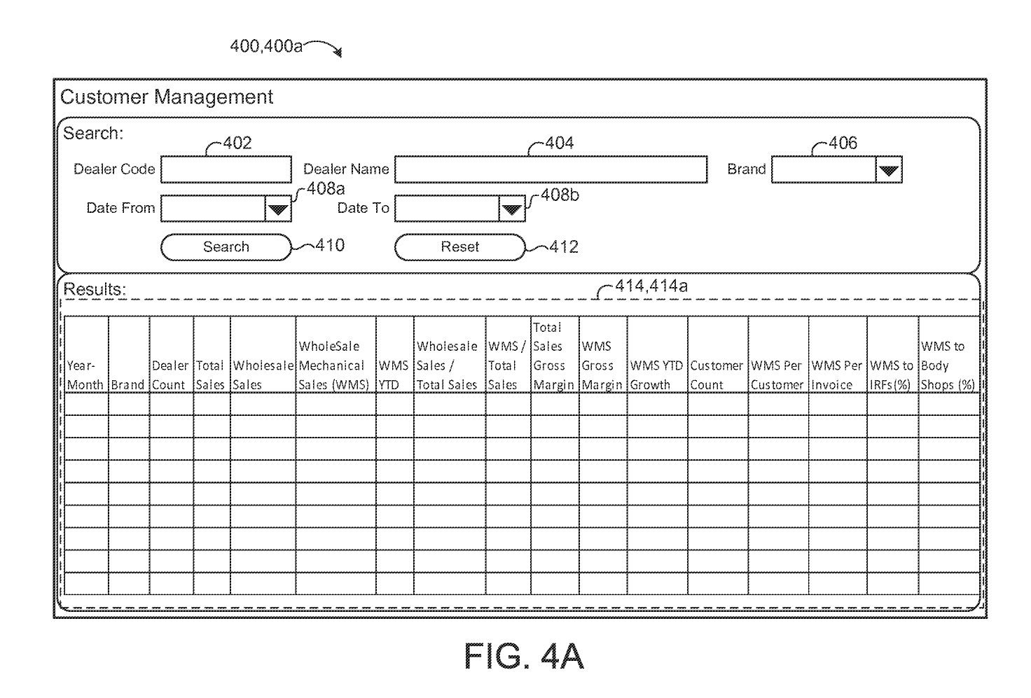

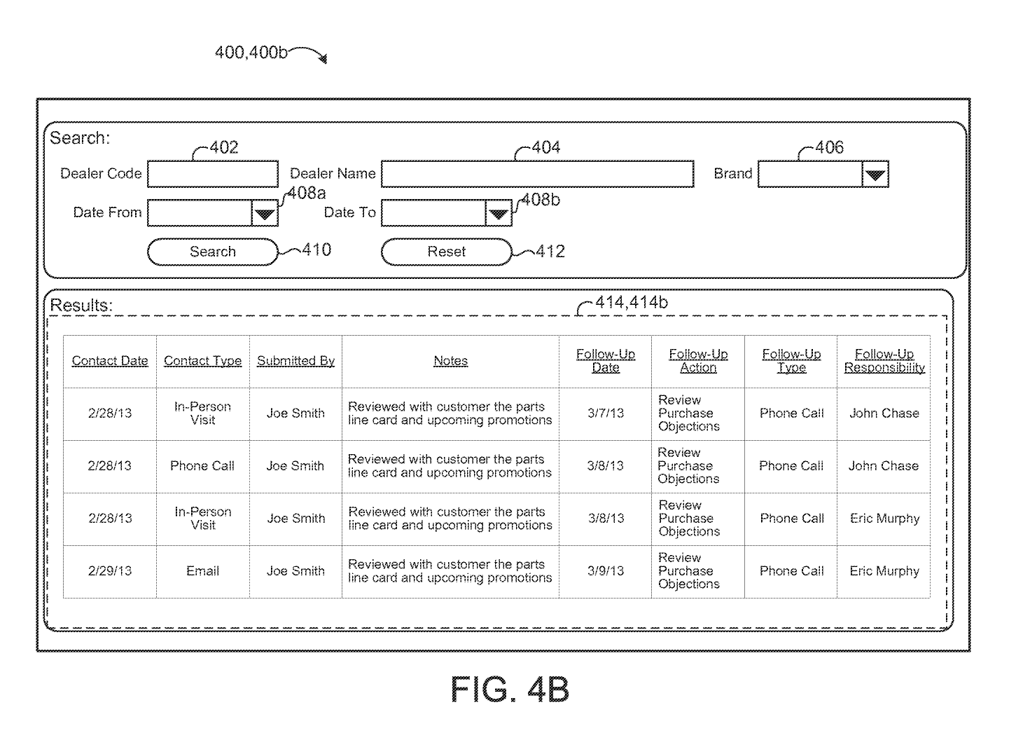

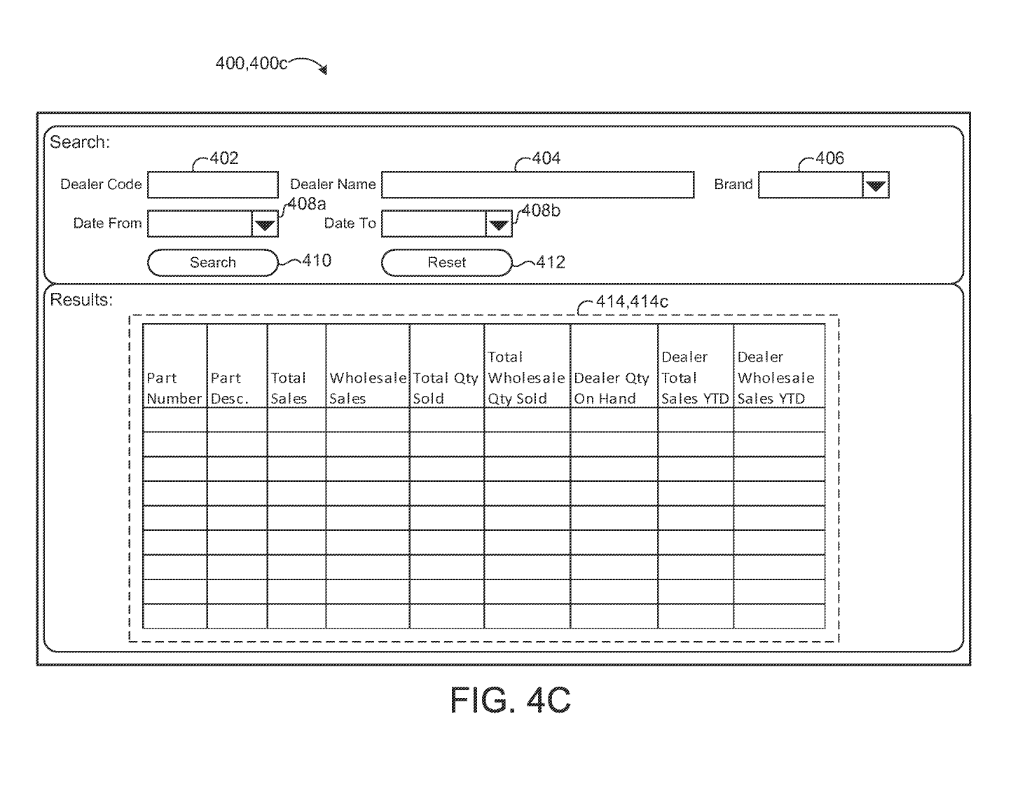

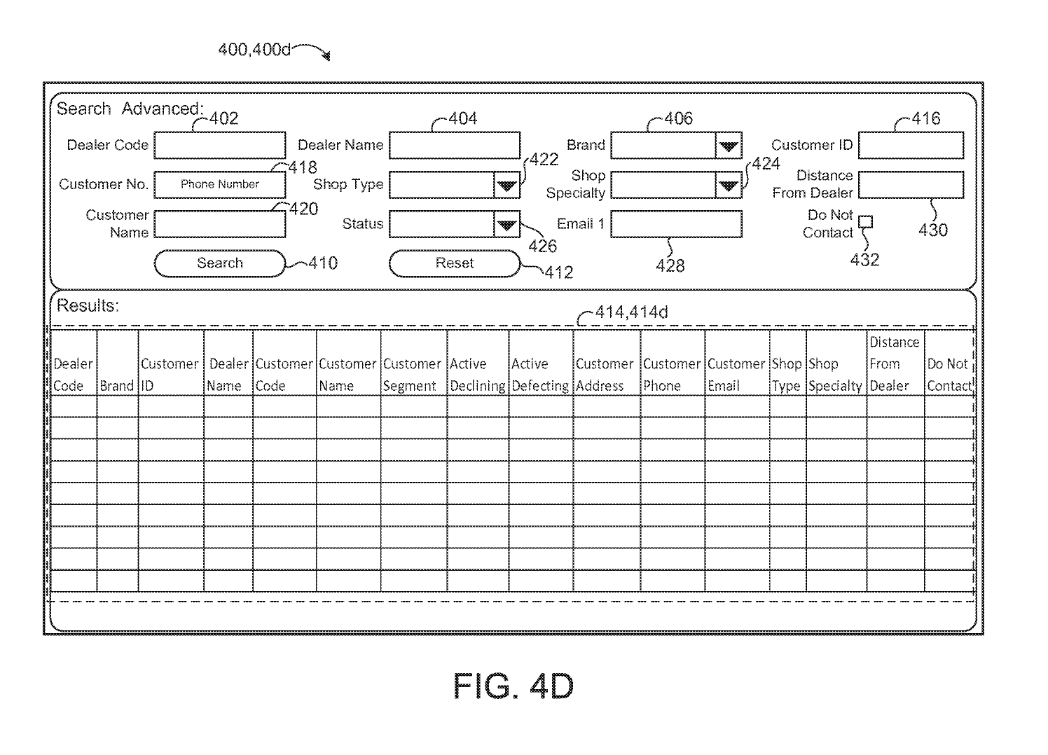

In some implementations, the system 100 includes an electronic display 206, 116 in communication with the system data processor 110. The display 206, 116 is configured to display one or more segmentation criteria input fields and receives the segmentation criteria 142 from one or more segmentation criteria input fields (FIGS. 4A-4D). The electronic display 206, 116 may be a handheld device 26 or a display wirelessly connected to the system processor 110. In some examples, certain portions of the report are only available to one or the other of the handheld device 26 or the wirelessly connected display 116.

In some examples, to accumulate all the customer records 210, each seller 20 has a customer record system 200 that allows the seller 20 to collect customer information and generate the customer records 210. The seller 20 interacts with multiple individual customers 10 purchasing a good from the seller 20. The seller 20 is the seller or provider of a good or service, and the customer 10 purchases goods or services from the seller 20. The customer record 210 includes a cumulative of all the information collected from each individual customer 10. The customer record system 200 is a system data processor (e.g., computing device) having non-transitory memory 202. The customer record system 200 includes a customer display 206 for displaying a customer interface 208 that allows the seller 20 to input purchaser information from customers 10. The purchaser information that may be entered in the customer record system 200 and stored in the non-transitory memory 202 of the customer record system 200 (retrieved by the customer receiver 130) may include a purchaser name, address, phone number, date of service or purchase, item or object purchase, type of service rendered, or any other information. In some examples, the customer display 206 is in communication with the customer record system 200 and displays the interactive report 152 generated by the reporter 150.

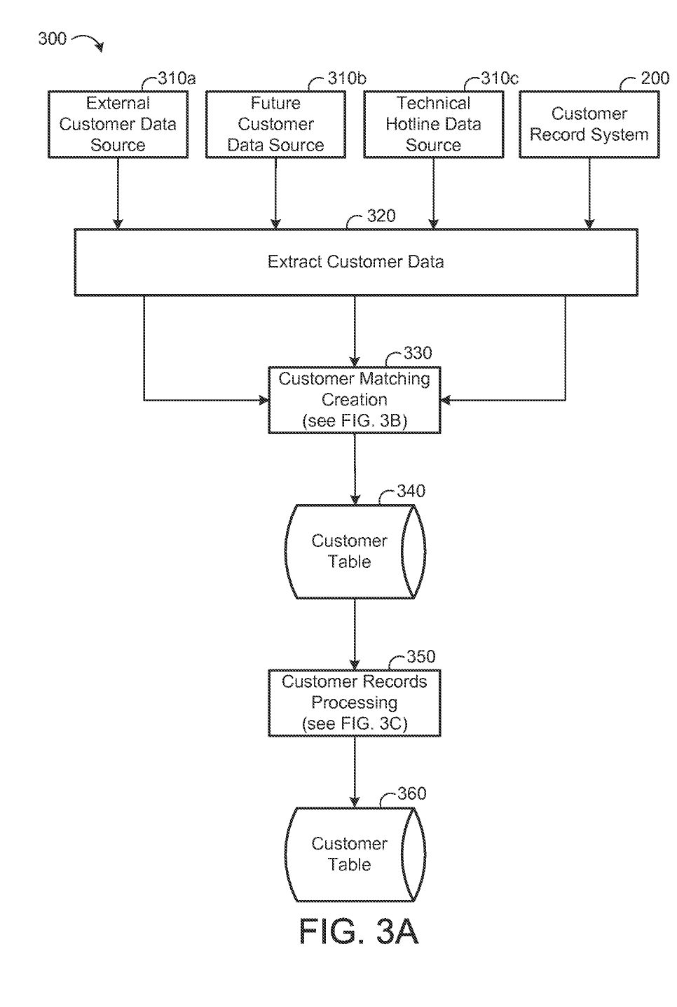

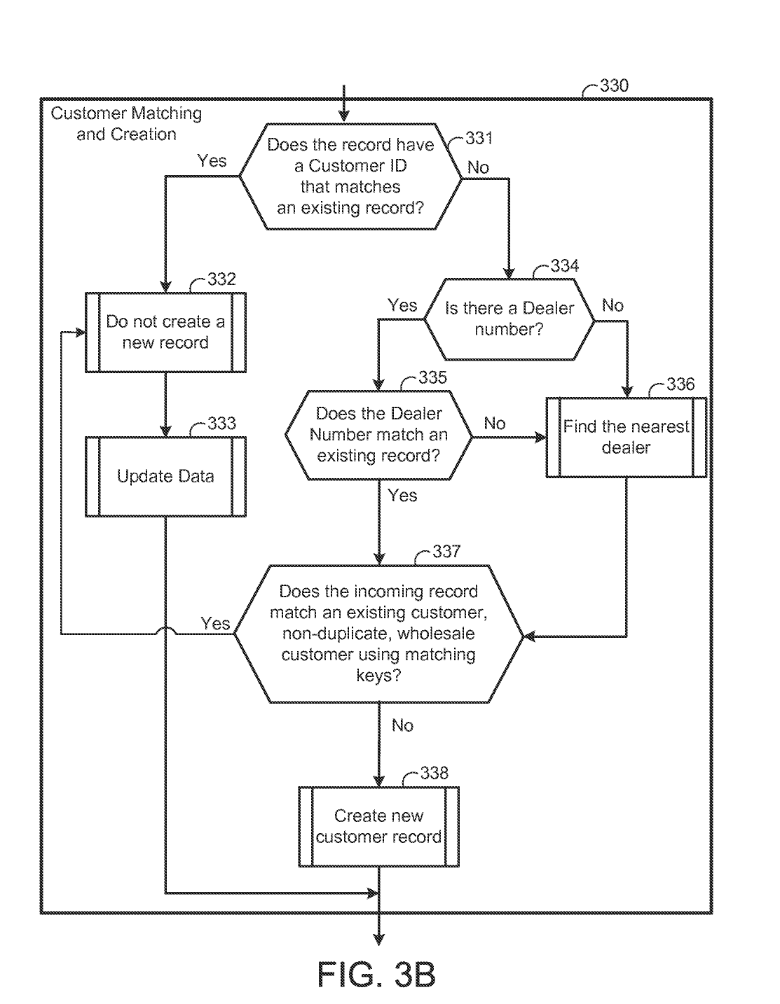

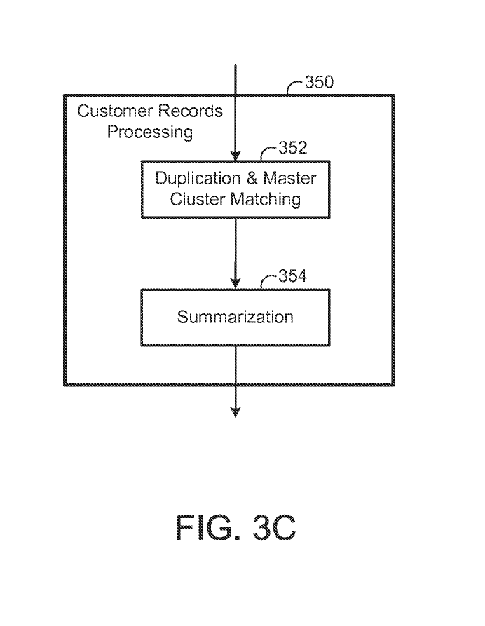

Referring to FIGS. 3A to 3C, the system 200 executes a process 300 executing on the data processor 110. The process 300 creates and updates customer records 210. The customer records 210 may be retrieved from different sources, such as external customer data 310a, a future customer data source 310b, a technical hotline data source 310c, or from the customer record system 200. An external customer data source 310a includes customer records 210 retrieved from external sources other than future customer data sources 310b, technical hotline data sources 310c, or the customer record system 200. For example, a manager 30 may meet a customer 10 and manually enter a customer record 210 into the system 200. The manager 30 enters the customer's information via the seller interface 118. A future customer data source 310 includes customer records 210 of potential customers 10 that have not made purchases from a seller 20. A technical hotline data source 310c includes customer records 210 of customers 10 who call a hotline (phone number) provided by the seller 20 or the manager 30 to ask questions or schedule appointments for services. Once the customer records 210 are retrieved (by the customer receiver 130) at block 320, the process 300 initiates customer matching creation at block 330. This process 320 includes record consolidation (FIG. 2B) and determining any record duplicates already stored in the data store 120.

Referring to FIG. 3B, at decision block 331, the customer receiver 130 determines if the customer record 210 has any duplicates between the received customer record 210 and a stored customer record 122 (stored in the data store 120). In some examples, each stored customer record 122 is associated with a customer ID. Therefore, the customer retriever 130 may compare a customer ID of the retrieved customer record 210 and the customer ID of the stored customer record 122 and, based on the customer ID, determine if there is a duplicate record. If the retrieved customer record 210 does not have customer ID associated with it, then the customer retriever 130 may use other parameters to determine if there is a duplicate record. These other parameters may include a customer name, a customer phone number, and a customer address. Other parameters are possible as well.

If the customer receiver 130 determines that the customer record 210 has a duplicate stored customer record 122, then the customer receiver 130 does not create a new customer record 210 (block 332). However, at block 333, the customer receiver 130 retrieves and updates the existing customer record 122 in the data store 120 based on the corresponding received customer record 210; therefore, the customer receiver 130 updates the stored customer record 122. In some examples, if there is a mismatch between the stored customer record 122 and the retrieved customer record 210, the customer receiver 130 may keep the stored customer record 122 as it is without updating the stored customer record 122 with the retrieved customer record 210. In other examples, the customer receiver 130 may override or delete stored customer records 122 and replace the stored customer records 122 with the retrieved customer records 210. In yet another example, the customer receiver 130 may maintain the stored customer record 122 and add the retrieved customer record 210. The customer receiver 130 may associate each customer data entry 122, 210 with a timestamp.

Referring back to block 331, if the stored record 122 does not match the current customer record 210, then the customer receiver 130 determines at block 334 whether the received customer records 210 include a seller phone number associated with a seller 20. If the customer receiver 130 determines that the received customer record 210 does not include cellular phone number, the customer receiver 130, at block 336, locates a nearest seller 20. The process 300 then goes to block 337. If the customer receiver 130 determines that the received customer record 210 includes a seller phone number, the customer receiver 130 determines, at block 335, if the phone number of the seller 20 (dealer) matches an existing phone number of a stored customer record 122. If the customer receiver 130 fails to determine that the seller phone number matches an existing seller phone number (stored as part of the stored data record 122), the process 300 moves to block 336 to locate a nearest seller 20. If however, the condition at block 335 is true, then the customer retriever 130 determines, at block 337, if the received record 210 matches a stored customer record 122 (non-duplicate record) using key terms. If the customer receiver 130 determines that the received customer record 210 matches a stored customer record 122 (by way of matching key terms), then the customer receiver 130 does not create a new record (block 332). If however, at block 337, the customer receiver 130 fails to match a customer record 122 with the received customer record 210, then the receiver 130 creates a new customer record 210 at block 338 and stores the new customer record 122 at the data store 120.

Referring back to FIG. 3A, once the process 300 completes customer matching and creation, at block 330, the customer receiver 130 creates a customer table 124, at block 340. The customer table 124 includes all information relevant to the customer 10, such as customer type 144 (dealer, body shop, a repair shop, a shop specialty, a distance from a dealer, and/or a brand), customer status 146 (active 146a (active defecting 146aa, active declining 146ab), inactive 164b, prospective 146c)), customer ID, customer name, customer, telephone number, website, email address, purchases made, log of times the customer 10 visits a seller 20, and any other information pertaining to the customer.

After the customer table 124 becomes available, the process 300 processes the customer table 124 and determines if there are any duplicate records that have not been previously located. Referring to FIG. 3C, at block 352, the process 300, executing on the data processor 110, determines if there are any duplicate records within the customer table 124 and combines these records. For example, if a customer 10 buys goods from two different sellers 20, there might be two different store data entries. This process consolidates these two entries and combines them into one stored customer record 122. At block 354, the process 300 may provide a summary of the stored customer records 122. Finally, at block 360 (FIG. 3A), the customer table 124 is updated with the stored customer record 122 retrieved from multiple sellers 20.

FIGS. 4A-4D illustrate exemplary displayable customer management views 400. Referring to FIG. 4A, a first customer management view 400a allows the manager 30 to sort through the stored customer records 122 stored in the data store 120.

The manager 30 enters information via the seller interface 118, and the segmenter 140 retrieves information, i.e., the segmentation criteria 142, entered by the manager 30 and segments the stored customer records 122 based on the segmentation criteria 142. Then, the reporter 150 reports the stored customer records 122 back to the seller based on the segmentation criteria 142 entered by the manager 30. The customer management screenshot 400a includes a seller code input field 402 and a seller name field 404. The seller code or seller ID is an identification number identifying the seller 20.

In some examples, the customer management screenshot 400a includes a brand field 406, which allows the manager 30 to further narrow the segmentation criteria 142 entered resulting in a narrower search result 414. For example, if the seller 20 is a car dealer, the seller 20 might be selling parts related to multiple car brands. Therefore, the brand field 406 allows the manager 30 to narrow their search based on specific car brands. The customer management screenshot 400a may also include date range fields 408, which allow the manager 30 to enter a date range and further narrow the search results 414. The manager 30 selects a search button 410, allowing the segmenter 140 to segment the stored customer records 122 organized in tables 124, which when completed are displayed on the seller display 116. Once the manager 30 selects the search button 410, a result set 414a appears on the display 116. The search results 414a include information related to the customers 10 and the sellers 20. As shown, the result set 414a includes a current date, brand, total sales seller 20, customer account, and other information pertaining to transactions between the seller 20 and the customer 10. The manager 30 may also select a reset button 412 that clears the entered information, allowing the manager 30 to reenter that information.

FIG. 4B is similar to FIG. 4A, however, the result sets 414a, 414b of each figure are different. FIG. 4B illustrates a second customer management view 400b providing a communication result set 414b showing a history of communication between the manager 30 and the seller 20. Some of the information displayed in the result set 414b includes contact date, contact type (in person visit, over the phone, or via email), the name of a person associated with the customer 10 to contact, any notes during the communication, date to follow up, follow up action, follow-up type, and the person responsible to follow up. Therefore, the system 100 allows the manager 30 to keep track of any and all communication with the seller 20, in addition to keeping track of the purchases.

FIG. 4C illustrates a third customer management view 400c with a different result set 414. The result set 414c of FIG. 4C includes information regarding the product(s) being sold, which includes part numbers, part description, total number of sales per customer 10, wholesale sales (the total number of sales the manager 30 has sold, total quantity sold to the customer 10, total seller quantity sold to all sellers 20, customer quantity on hand, customer total sales year to day, manager 30 total sales for the year), and/or any other relevant information. The manager 30 may customize the information being displayed in the result sets 414c and include more or less information relating to the goods sold.

FIG. 4D illustrates an advanced search screen 400d, which allows the manager 30 to input more information to better segment the stored customer records 122 stored in the data store 120. The advanced search screen 400d includes input fields, such as: purchaser ID 416, purchaser phone number 418, purchaser name 420, purchaser shop type 422 (e.g. dealer, body shop, a repair shop, a shop specialty, a distance from a dealer, and/or a brand), purchaser shop specialty 424 (e.g., service, parts, service and parts), purchaser status 426 (active 146a (active defection 146aa, active declining 146ab), inactive 146b, prospective 146c)), purchaser email 428, distance 430 from the purchaser location (store) to the location of the seller 20 from which the purchaser made the purchase, and a do not contact box 432 (once marked, the manager 30 may not contact the purchaser directly). The result set 414d includes information relating to the seller 20 and the customer 10, including brand customer type, customer status and other customer 10 information.

In some examples, the manager 30 alternates between the different result sets 414. The user interface may include tabs allowing the seller 30 to switch between the search result sets 414.

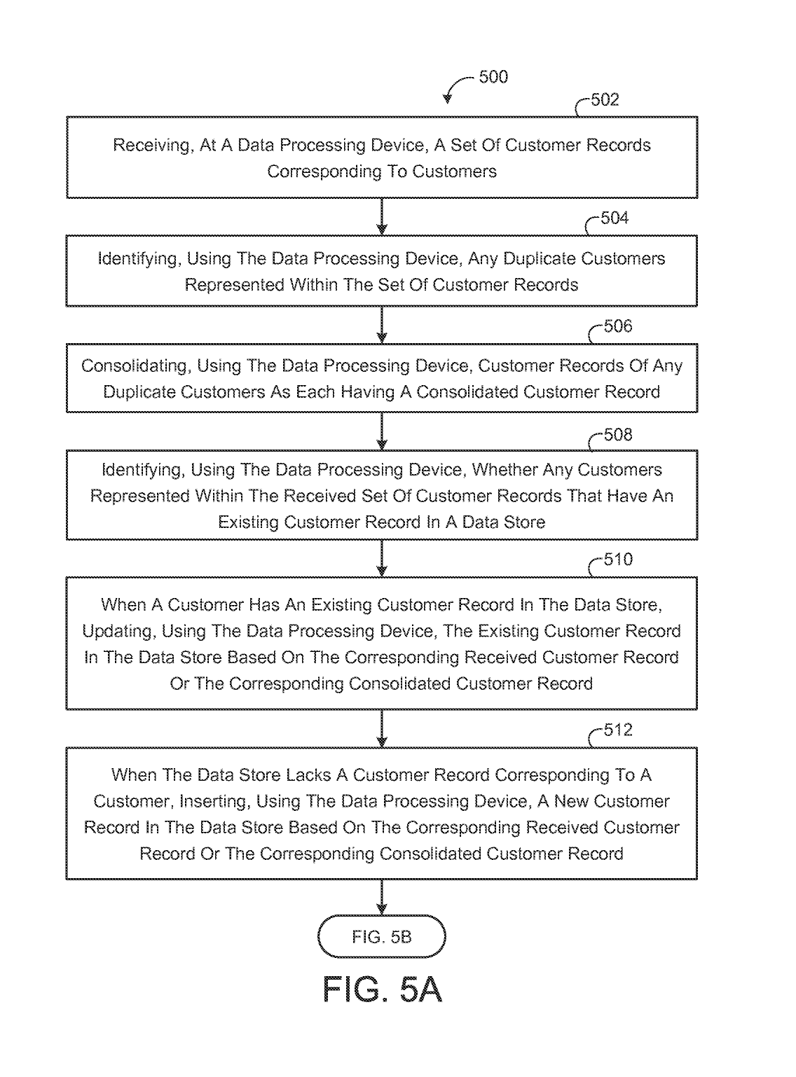

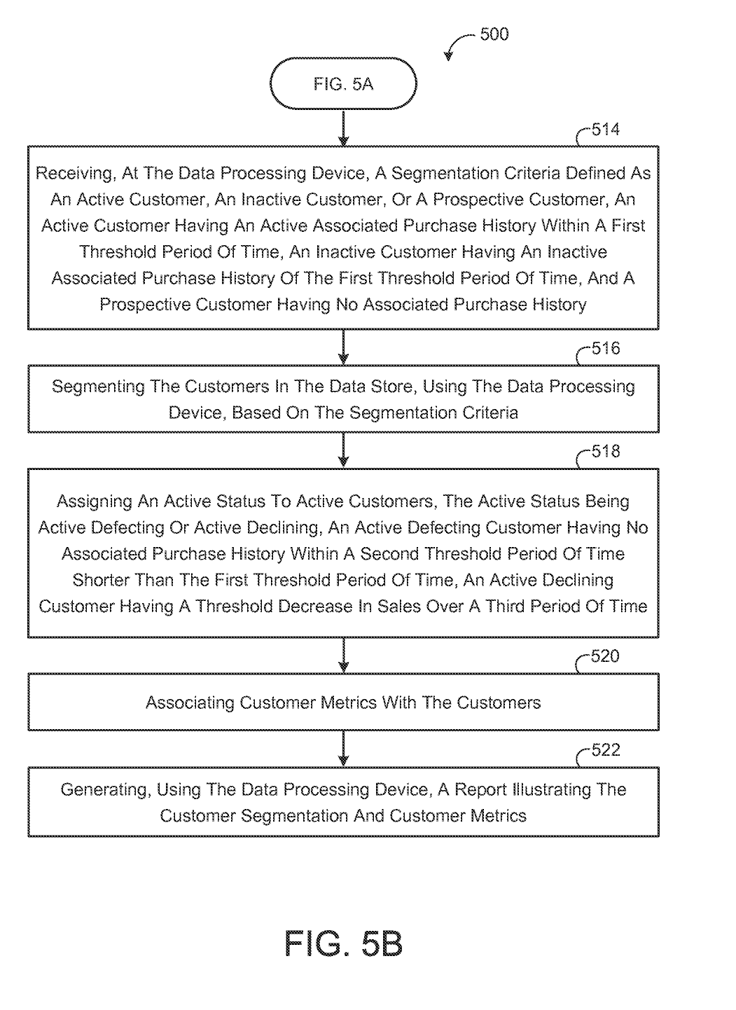

Referring to FIGS. 5A and 5B, a method 500 includes receiving 502, at a data processing device 110, a set 211 of customer records 210 corresponding to customers 10 and identifying 504, using the data processing device 110, any duplicate customers 10 represented within the set 211 of customer records 210. The method 500 also includes consolidating 506, using the data processing device 110, customer records 210 of any duplicate customers 10 as each having a consolidated customer record 212 and identifying, 508 using the data processing device 110, whether any customers 10 represented within the received set 211 of customer records 210 have an existing customer record 122 in a data store 120. When a customer 10 has an existing customer record 122 in the data store 120, the method 500 includes updating 510, using the data processing device 110, the existing customer record 122 in the data store 120 based on the corresponding received customer record 210 or the corresponding consolidated customer record 212. Moreover, when the data store 120 lacks a customer record 122 corresponding to a customer 10, the method 500 includes inserting using the data processing device 110, anew customer record 122 in the data store 120 based on the corresponding received customer record 210 or the corresponding consolidated customer record 212. The method 500 also includes receiving 514, at the data processing device 110, a segmentation criteria 142 defined as an active customer 146a, an inactive customer 146b, or a prospective customer 146c. An active customer 146a has an active associated purchase history within a first threshold period of time, an inactive customer 146b has an inactive associated purchase history of the first threshold period of time, and a prospective customer 146c has no associated purchase history. The method 500 includes segmenting the customers 10 in the data store 120, using the data processing device 110, based on the segmentation criteria 142. The method 500 also includes assigning an active status 146a to active customers 10, the active status 146a being active defecting status 146aa or active declining status 146ab. A customer 10 having an active defecting status 146aa has no associated purchase history within a second threshold period of time shorter than the first threshold period of time, and an active declining customer 146ab has a threshold decrease in sales over a third period of time. The method 500 finally includes associating customer metrics 154 with the customers 10, and generating, using the data processing device 110, a report 152 illustrating the customer segmentation 148 and customer metrics 154.

In some implementations, the method 500 further includes displaying on an electronic display 26, 116, 206 one or more segmentation criteria input fields and receiving the segmentation criteria 142 from one or more segmentation criteria input fields. The segmentation criteria 142 include a customer type 144 and a customer status 146 within the customer type 144. The customer type 144 is defined as a dealer, body shop, a repair shop, a shop specialty, a distance from a dealer, and/or a brand.

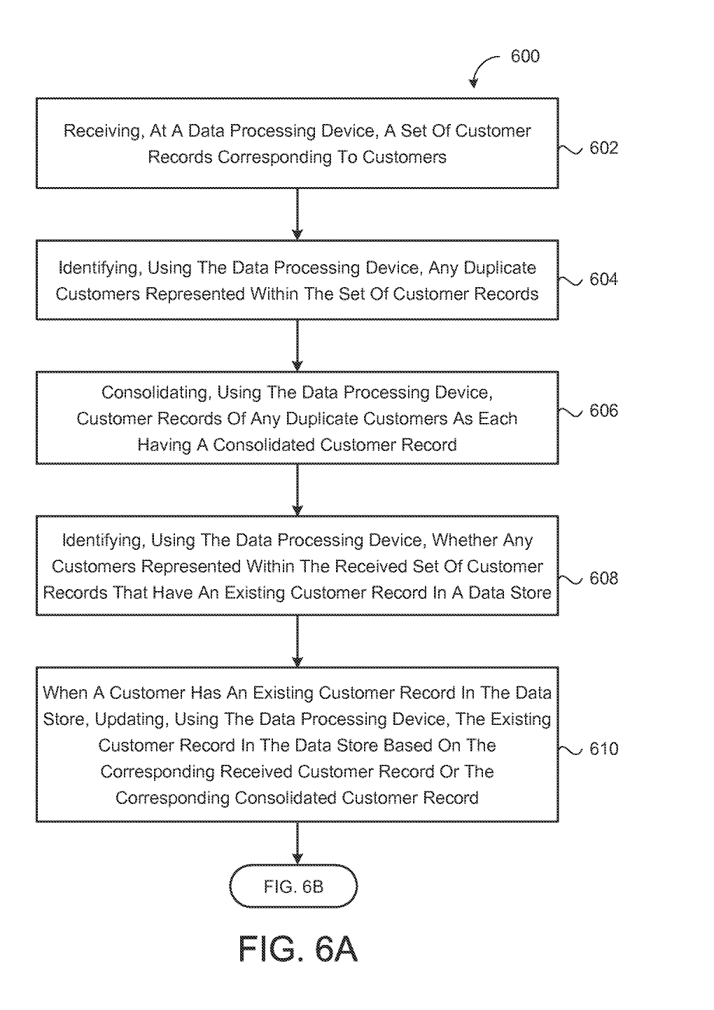

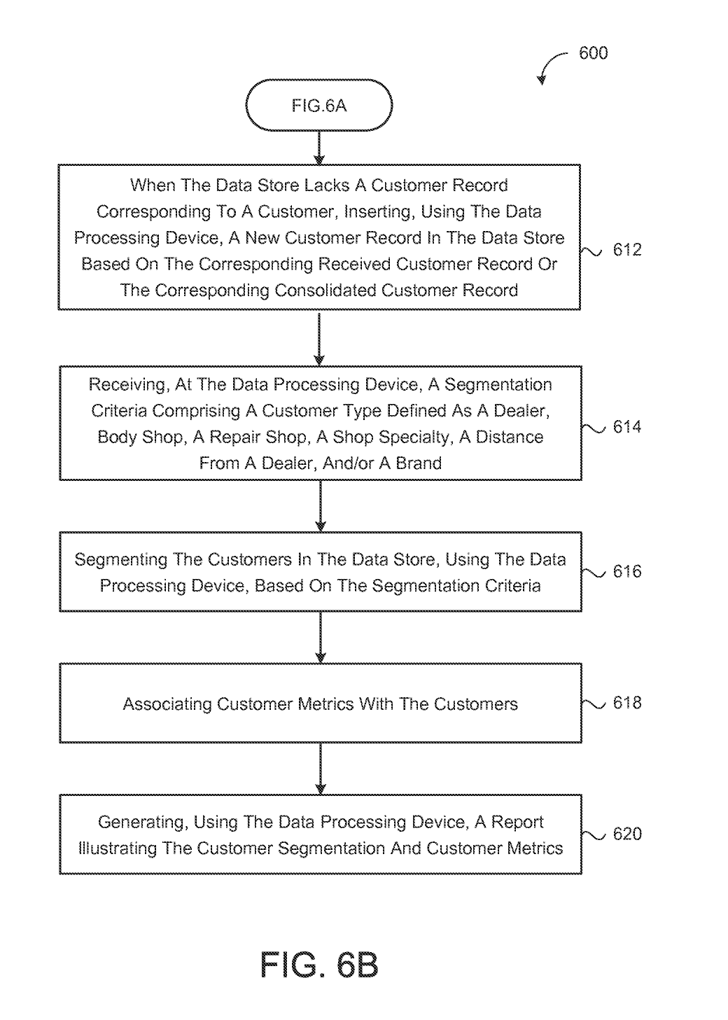

Referring to FIGS. 6A and 6B, a method 600 including: receiving 602, at a data processing device 110, a set of customer records 210 corresponding to customers and identifying 604, using the data processing device 110, any duplicate customers 10 represented within the set 211 of customer records 210 is shown. The method 600 also includes consolidating 606, using the data processing device 110, customer records 210 of any duplicate customers 10 as each having a consolidated customer record 212 and identifying 608, using the data processing device 110, whether any customers 10 represented within the received set 211 of customer records 210 have an existing customer record 122 in a data store 120. The method 600 also includes when a customer has an existing customer record 122 in the data store 120, updating 610, using the data processing device 110, the existing customer record 122 in the data store 120 based on the corresponding received customer record 210 or the corresponding consolidated customer record 212. The method 600 also includes when the data store 120 lacks a customer record 210 corresponding to a customer 10, inserting, using the data processing device 110, a new customer record 122 in the data store 120 based on the corresponding received customer record 210 or the corresponding consolidated customer record 212. The method 600 also includes receiving, at the data processing device 110, a segmentation criteria 142 including a customer type 144 defined as a dealer, body shop, a repair shop, a shop specialty, a distance from a dealer, and/or a brand. The method 600 also includes segmenting the customers 10 in the data store 120, using the data processing device 110, based on the segmentation criteria 142 and associating customer metrics 154 with the customers 10. The method 600 also includes generating, using the data processing device 110, a report 152 illustrating the customer segmentation 148 and customer metrics 154.

In some implementations, the segmentation criteria 142 includes a customer type 144 defined as an active customer 146a, an inactive customer 146b, or a prospective customer 146c. An active customer 146a has an active associated purchase history within a first threshold period of time, an inactive customer 146b has an inactive associated purchase history of the first threshold period of time, and a prospective customer 146c has no associated purchase history. The method 600 may further include assigning an active status 146a to active customers, the active status 146a being active defecting 146aa or active declining 146ab. An active defecting customer 146aa has no associated purchase history within a second threshold period of time shorter than the first threshold period of time and an active declining customer 146ab has a threshold decrease in sales over a third period of time.

Referring back to FIGS. 5A-6B, the method 500, 600 may further include determining the customer type 144 of each customer 10 based on a name of the customer 10 or based on a word match between a list of words and a name of the customer 10.

In some examples, the method 500, 600 includes generating and displaying on the electronic display 26, 216, 206 an interactive report 152 that provides cascading information for the customer type 144 and the customer status 146. The customer metrics 154 may include sales and generating the report 152 may include generating a table or graphical illustration illustrating a sales trend over a period of time.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving, at a data processing device, a set of customer records corresponding to customers;
identifying, using the data processing device, any duplicate customers represented within the set of customer records;
consolidating, using the data processing device, customer records of any duplicate customers as each having a consolidated customer record;
identifying, using the data processing device, whether any customers represented within the received set of customer records have an existing customer record in data store hardware;
when a customer has an existing customer record in the data store hardware, updating, using the data processing device, the existing customer record in the data store hardware based on the corresponding received customer record or the corresponding consolidated customer record;
when the data store hardware lacks a customer record corresponding to a customer, inserting, using the data processing device, a new customer record in the data store hardware based on the corresponding received customer record or the corresponding consolidated customer record;
receiving, at the data processing device, a segmentation criteria defined as an active customer, an inactive customer, or a prospective customer, an active customer having an active associated purchase history within a first threshold period of time, an inactive customer having an inactive associated purchase history of the first threshold period of time, and a prospective customer having no associated purchase history;
segmenting the customers in the data store hardware, using the data processing device, based on the segmentation criteria;
assigning an active status to active customers, the active status being active defecting or active declining, an active defecting customer having no associated purchase history within a second threshold period of time shorter than the first threshold period of time, an active declining customer having a threshold decrease in sales over a third period of time;
associating customer metrics with the customers; and
generating, using the data processing device, a report illustrating the customer segmentation and customer metrics.

2. The method of claim 1, further comprising:
displaying on an electronic display one or more segmentation criteria input fields; and
receiving the segmentation criteria from one or more segmentation criteria input fields;
wherein the segmentation criteria comprises a customer type and a customer status within the customer type.

3. The method of claim 2, further comprising receiving a customer type defined as a dealer, body shop, a repair shop, a shop specialty, a distance from a dealer, and/or a brand.

4. The method of claim 3, further comprising determining the customer type of each customer based on a name of the customer.

5. The method of claim 3, further comprising determining the customer type based of each customer a word match between a list of words and a name of the customer.

6. The method of claim 2, wherein generating the report comprises generating and displaying on the electronic display an interactive report that provides cascading information for the customer type and the customer status.

7. The method of claim 1, wherein the customer metrics comprise sales and generating the report comprises generating a table or graphical illustration illustrating a sales trend over a period of time.

8. A method comprising:
receiving, at a data processing device, a set of customer records corresponding to customers;
identifying, using the data processing device, any duplicate customers represented within the set of customer records;
consolidating, using the data processing device, customer records of any duplicate customers as each having a consolidated customer record;
identifying, using the data processing device, whether any customers represented within the received set of customer records that have an existing customer record in data store hardware;
when a customer has an existing customer record in the data store hardware, updating, using the data processing device, the existing customer record in the data store hardware based on the corresponding received customer record or the corresponding consolidated customer record;
when the data store hardware lacks a customer record corresponding to a customer, inserting, using the data processing device, a new customer record in the data store hardware based on the corresponding received customer record or the corresponding consolidated customer record;
receiving, at the data processing device, a segmentation criteria comprising a customer type defined as a dealer, body shop, a repair shop, a shop specialty, a distance from a dealer, and/or a brand;
segmenting the customers in the data store hardware, using the data processing device, based on the segmentation criteria;
associating customer metrics with the customers; and
generating, using the data processing device, a report illustrating the customer segmentation and customer metrics.

9. The method of claim 8, further comprising determining the customer type of each customer based on a name of the customer.

10. The method of claim 8, further comprising determining the customer type based of each customer a word match between a list of words and a name of the customer.

11. The method of claim 8, wherein the segmentation criteria comprises a customer status defined as an active customer, an inactive customer, or a prospective customer.

12. The method of claim 11, wherein an active customer has an active associated purchase history within a first threshold period of time, an inactive customer has an inactive associated purchase history of the first threshold period of time, and a prospective customer has no associated purchase history.

13. The method of claim 12, further comprising assigning an active status to active customers, the active status being active defecting or active declining, an active defecting customer having no associated purchase history within a second threshold period of time shorter than the first threshold period of time, an active declining customer having a threshold decrease in sales over a third period of time.

14. The method of claim 8, further comprising:
displaying on an electronic display one or more segmentation criteria input fields; and
receiving the segmentation criteria from one or more segmentation criteria input fields;
wherein the segmentation criteria comprises a customer type and a customer status within the customer type.

15. The method of claim 14, wherein generating the report comprises generating and displaying on the electronic display an interactive report that provides cascading information for the customer type and the customer status.

16. The method of claim 8, wherein the customer metrics comprise sales and generating the report comprises generating a table or graphical illustration illustrating a sales trend over a period of time.

17. A system comprising:
data store hardware;
a customer receiver executing on a data processing device and in communication with the data store hardware, the customer receiver:
receiving a set of customer records corresponding to customers;
identifying any duplicate customers represented within the set of customer records;
consolidating customer records of any duplicate customers as each having a consolidated customer record;
identifying whether any customers represented within the received set of customer records that have an existing customer record in the data store hardware;
when a customer has an existing customer record in the data store hardware, updating the existing customer record in the data store hardware based on the corresponding received customer record or the corresponding consolidated customer record; and
when the data store hardware lacks a customer record corresponding to a customer, inserting a new customer record in the data store hardware based on the corresponding received customer record or the corresponding consolidated customer record;
a segmenter in communication with the data store hardware, the segmenter:
receiving a segmentation criteria; and
segmenting the customers in the data store hardware based on the segmentation criteria; and
a reporter in communication with the data store hardware, the reporter:
associating customer metrics with the customers; and
generating a report illustrating the customer segmentation and customer metrics.

18. The system of claim 17, wherein the segmentation criteria comprises a customer status defined as an active customer, an inactive customer, or a prospective customer.

19. The system of claim 18, wherein an active customer has an active associated purchase history within a first threshold period of time, an inactive customer has an inactive associated purchase history of the first threshold period of time, and a prospective customer has no associated purchase history.

20. The system of claim 19, wherein the segmenter assigns an active status to active customers, the active status being active defecting or active declining, an active defecting customer having no associated purchase history within a second threshold period of time shorter than the first threshold period of time, an active declining customer having a threshold decrease in sales over a third period of time.

21. The system of claim 17, further comprising an electronic display in communication with the data processing device, the electronic display:
displaying one or more segmentation criteria input fields; and
receiving the segmentation criteria from one or more segmentation criteria input fields;
wherein the segmentation criteria comprises a customer type and a customer status within the customer type.

22. The system of claim 21, wherein the segmentation criteria comprises a customer type defined as a dealer, body shop, a repair shop, a shop specialty, a distance from a dealer, and/or a brand.

23. The system of claim 22, wherein the segmenter determines the customer type of each customer based on a name of the customer.

24. The system of claim 22, wherein the segmenter determines the customer type based of each customer a word match between a list of words and a name of the customer.

25. The system of claim 21, wherein the reporter generates and displays on the electronic display an interactive report that provides cascading information for the customer type and the customer status.

26. The system of claim 17, wherein the customer metrics comprise sales and generating the report comprises generating a table or graphical illustration illustrating a sales trend over a period of time.
